(19) United States
(12) Patent Application Publication
(10) Pub. No.: US 2011/0185589 A1
(43) Pub. Date: Aug. 4, 2011

(54) DEVICE AND METHOD FOR THERMALLY PROCESSING WEB-LIKE FABRIC WEBS

(75) Inventor: Michael Christ, Stuttgart (DE)

(73) Assignee: Brückner Trockentechnik GmbH & Co. KG

(21) Appl. No.: 13/010,977

(22) Filed: Jan. 21, 2011

(30) Foreign Application Priority Data
Feb. 2, 2010 (DE) 10 2010 006 577.3

(51) Int. Cl. F26B 3/02; F26B 13/00; F26B 21/10

(52) U.S. Cl. 34/444; 34/618; 34/549

(57) ABSTRACT

The device according to the invention for thermally processing web-like fabric webs substantially comprises
a plurality of successive processing fields for acting on the fabric web with a processing gas,
transport means for conveying the fabric web through the processing fields in the extended state,
devices for supplying additional air to the processing fields,
devices for discharging exhaust air from the processing fields,
a mixing device which is provided in each processing field and which is connected to the devices for supplying the additional air and which has an adjustment member, the ratio of additional air to circulating recirculation air present in the processing gas thereby being able to be adjusted, and
a central heating system which is for adjusting the temperature of the processing gas and which is connected to the plurality of processing fields by means of a ring circuit.

### TECHNICAL FIELD

The invention relates to a device and a method for thermally-processing web-like, in particular textile, fabric webs with a plurality of successive processing fields.

### BACKGROUND OF THE INVENTION

According to DE 100 10 842 B4, the device for processing fabric webs, in particular for drying textile fabric webs, substantially comprises a housing, at least one processing field for acting on the fabric web with a processing gas, devices for supplying fresh air into the housing and devices for discharging exhaust air which is loaded with moisture from the housing. In the processing field, there is further provided a mixing device which provides one or more supply openings for the circulating recirculation air, one or more supply openings for the fresh air and a discharge opening for the processing gas and which further has adjustment means by means of which the ratio of fresh air to circulating recirculation air present in the processing gas can be adjusted.

In addition, in the region of the mixing device there is provided a combustion device which has a flame supply pipe, with supply openings which are arranged concentrically around the flame supply pipe being provided for the circulating recirculation air and fresh air. Using the mixing device, in addition to pure recirculation air operation and pure fresh air operation, it is also possible to adjust any desired ratio of fresh air to circulating recirculation air. In this manner, it is possible to adjust very selectively specific ratios in the individual processing fields depending on their position in the housing.

Owing to the high level of energy consumption during the thermal processing of textile fabric webs, it is desirable to implement energy-saving measures and at the same time to allow an increase in the efficiency of the thermal processing operation.

EP 1 830 146 A1 proposed to this end a device for thermally processing textile fabric webs which substantially comprises a plurality of successive processing zones which are constructed as oblique blasting ventilation zones and means for discharging the exhaust air of the oblique blasting ventilation zones. Furthermore, there is provided a processing zone which is arranged upstream of the fabric web in the transport direction and which is constructed as an aeration zone, the means for discharging the exhaust air from the oblique blasting ventilation zones being connected to the aeration zone in such a manner that the exhaust air is directed through the fabric web.

In the oblique blasting ventilation zones, the processing gas is blown, after the conventional heating by a combustion device, onto the fabric web in order, for example, to dry it, the processing gas absorbing the moisture. With the exhaust air in the upstream aeration zone being directed through the fabric web, the exhaust air can be further cooled to the cooling limit temperature, energy being supplied to the fabric web. This brings about an increase in the efficiency of the drying performance and saves energy.

Furthermore, it is known to supply exhaust air to a heat recovery system in order, for example, to preheat the fresh air which is to be supplied to the individual processing fields.

### SUMMARY OF THE INVENTION

An object of the invention is to implement further energy-saving measures.

According to the invention, this object is achieved by the features of claims 1 and 8.

The device according to the invention for thermally processing web-like, in particular textile, fabric webs substantially comprises
a plurality of successive processing fields for acting on the fabric web with a processing gas,
transport means for conveying the fabric web through the processing fields in the extended state,
devices for supplying additional air to the processing fields,
devices for discharging exhaust air from the processing fields,
a mixing device which is provided in each processing field and which is connected to the devices for supplying additional air and which has an adjustment member, the ratio of additional air to circulating recirculation air present in the processing gas thereby being able to be adjusted, and,
for adjusting the temperature of the processing gas, a central heating system which is connected to the plurality of processing fields by means of a ring circuit.

The method according to the invention for thermally processing web-like, in particular textile, fabric webs substantially has the following method steps:
the fabric web is conveyed through a plurality of successive processing fields and is acted on with a processing gas in the processing fields,
additional air is supplied to each processing field,
exhaust air is discharged from the processing fields,
the processing gas is adjusted in each processing field by mixing additional air with circulating recirculation air and
the temperature of the processing gas is adjusted by means of a central heating system which is connected to the plurality of processing fields by means of a ring circuit.

In the previously known devices for thermally processing web-like, in particular textile, fabric webs, the processing gas is brought to the required temperature by means of combustion devices which are arranged in each processing field.

In this instance, it had to be taken into account that the combustion devices in different processing fields have to be partially operated at different power levels. Furthermore, the required thermal power can vary in particular owing to the properties of the fabric web and/or a changing ratio of additional air and circulating recirculation air so that the combustion devices cannot always be operated at the optimal operating point and thereby often cannot utilise their full efficiency.

Owing to the provision of a central heating device together with a ring circuit, the heat required for the adjustment of the temperature of the processing gas can be produced centrally. Each processing device removes only the required quantity of heat, the quantity of heat not removed being returned via the ring circuit. In this manner, the central heating device, in particular a central combustion chamber, can always be operated in the optimum adjustment range, whereby a more complete burn-out and better use of energy are ensured. Furthermore, replacing the plurality of burners (in the individual processing fields) with a central heating system provides a clear cost saving.

The dependent claims relate to other configurations of the invention.

According to a first embodiment of the invention, the central heating system is constructed to heat the additional air and the devices for supplying the additional air are formed by the ring circuit, which in turn is connected to the mixing devices of the plurality of processing fields. The additional air is thereby centrally heated and supplied to the individual processing fields via the ring circuit, whilst excess additional air is returned to the central heating system.

Further heating of the processing flow in the individual processing fields is then no longer necessary. Via the mixing devices together with appropriate control, the temperature of the processing gas can thereby be adjusted in a significantly more precise manner than with separate combustion devices arranged in the processing fields.

According to a second embodiment of the invention, the processing fields each comprise a heat exchanger for heating the processing gas, the heat exchangers of the processing fields being connected to the central heating system at their hot side via the ring circuit. This configuration allows indirect heating of the processing gas, which is particularly suitable for the thermal processing of sensitive textile fabric webs which must not be exposed to any exhaust gas.

In the second embodiment, the central heating system may have a first heating device, in particular a combustion chamber, and a second heating device, in particular a heat exchanger,
the first heating device being constructed for heating circuit air and being connected via the ring circuit to the hot side of the heat exchangers in the plurality of processing fields and
the second heating device being constructed for heating the additional air and being connected to the mixing devices of the plurality of processing fields via the devices for supplying the additional air.

According to another configuration, the central heating system has a connection for supplying fresh air. Furthermore, there can be arranged, downstream of the processing fields, a cooling field which is operated with fresh air and which has a connection for supplying fresh air and a connection which is connected to the central heating system for discharging preheated fresh air.

Via a control device, the central heating system can be controlled in accordance with at least one parameter of the exhaust air produced in the processing fields, in particular in accordance with the carbon content and/or the moisture and/or the temperature of the additional air.

### BRIEF DESCRIPTION OF THE DRAWINGS

Other advantages and configurations of the invention are explained in greater detail with reference to the following description and the drawings, in which:

FIGS. 1a to 1c are schematic circuit diagrams of the device according to the invention for thermally processing textile fabric webs in accordance with a first configuration of the invention,

FIGS. 2a to 2c are schematic circuit diagrams of the device according to the invention for thermally processing textile fabric webs in accordance with a second configuration of the invention,

FIG. 3 is a three-dimensional schematic illustration of the last processing field, and

FIG. 4 is a schematic plan view in the region below the nozzle system of the last processing field.

### DETAILED DESCRIPTION OF THE INVENTION

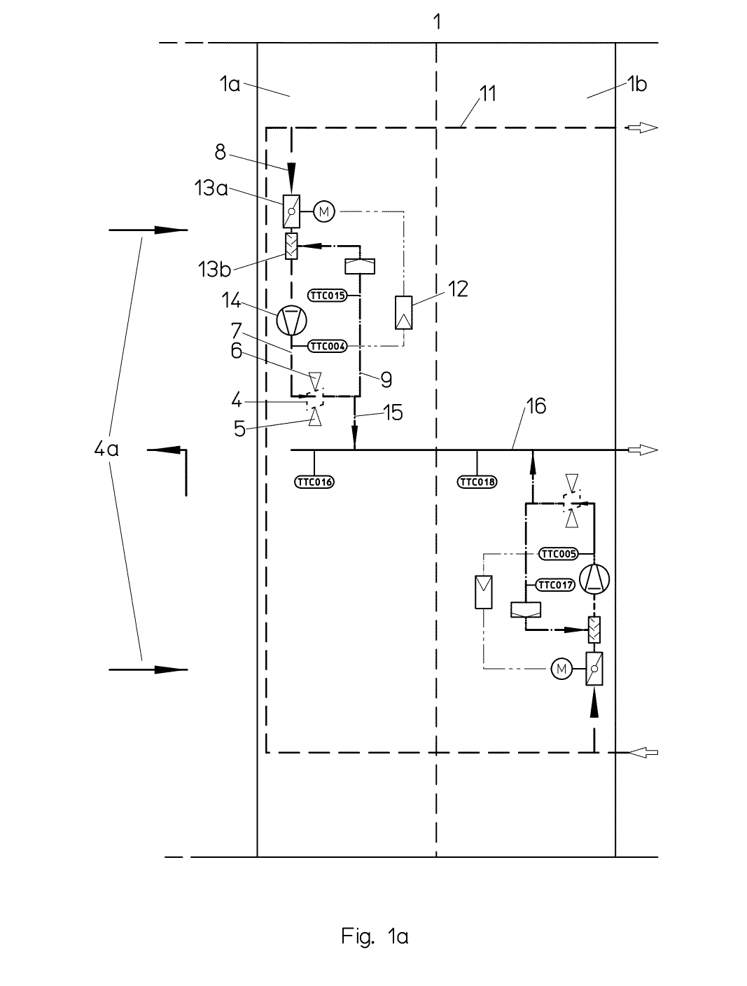

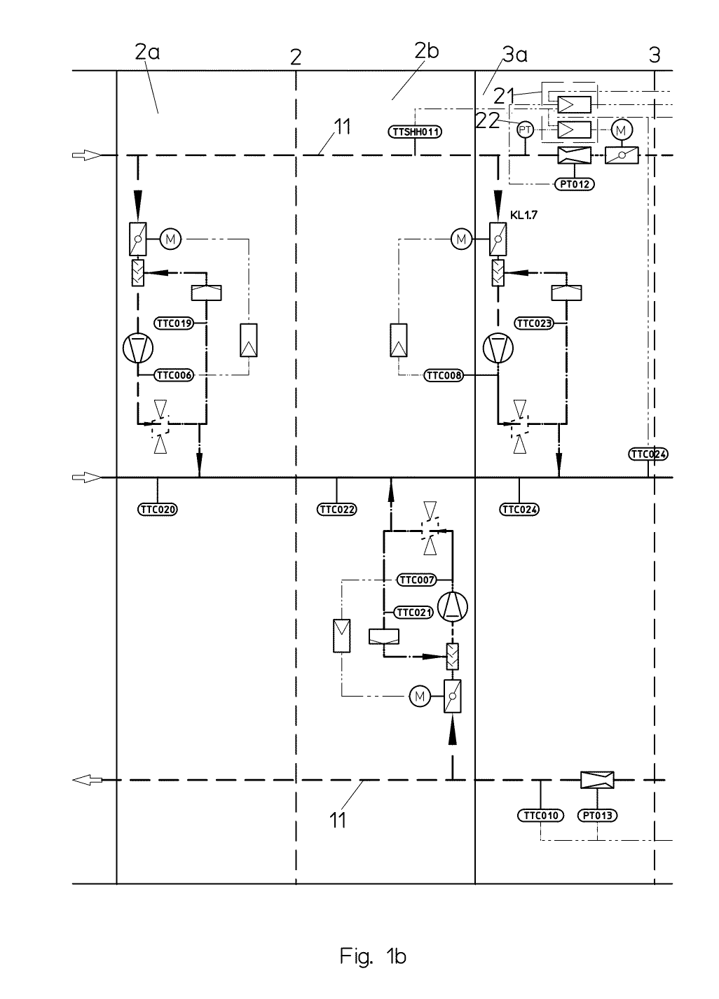

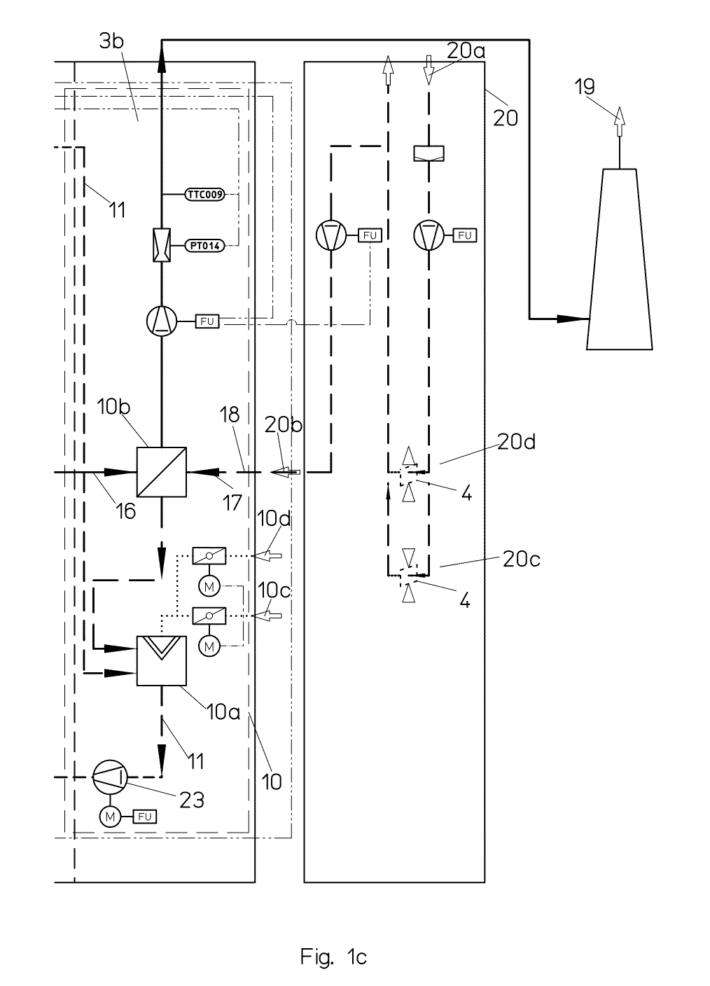

FIGS. 1a to 1c schematically illustrate a first embodiment of the invention. This is, for example, a device for thermally processing textile fabric webs. The fabric webs may also be, for example, a non-woven, coatings of textile carriers, such as coatings for carpet backings, synthetic leather and the like. In the context of the invention, however, other non-textile web-like fabric webs may also be considered.

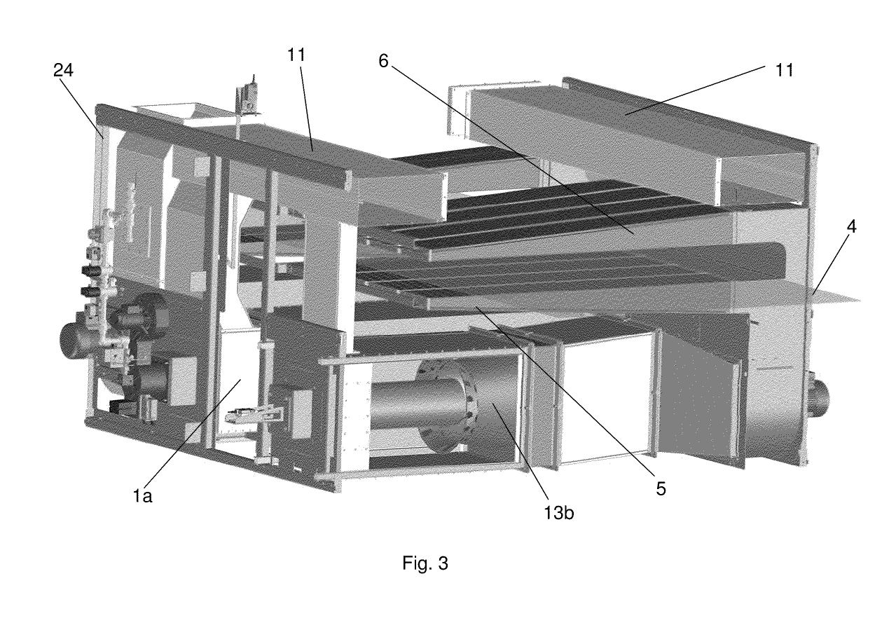

It comprises a plurality of successive processing fields 1 to 3 which are each divided into half-fields 1a, 1b; 2a, 2b; 3a, 3b, the last processing field 3 being illustrated in a three-dimensional diagram in FIG. 3. In the context of the invention, it is of course also possible to provide more or fewer processing fields. A textile fabric web 4 is conveyed in the extended state through the processing fields by transport means 4a which are schematically indicated only with arrows. In the processing fields, there are constructed oblique blasting ventilation zones with lower and upper nozzle systems 5, 6 which extend over the entire width of the fabric web so that the fabric web is acted on with a processing gas 7 both from above and from below.

With reference to the processing field 1 in FIG. 1a, the operating method of the processing fields will be explained below in greater detail.

The processing gas 7 is composed of a specific ratio of additional air 8 and circulating recirculation air 9, the additional air 8 being heated in a central heating system 10 (FIG. 1c) and being supplied to the individual processing fields 1 to 3 via a ring circuit 11. By means of a temperature-controlled adjustment device 12, an adjustment member 13a which is arranged upstream of a mixing device 13b is controlled in order to maintain the temperature of the processing gas 7 at a predetermined level of, for example, 200° C., by the addition of hot additional air 8. Depending on the type of processing operation, different temperatures can also be adjusted in the individual processing fields.

The processing gas 7 is applied to the fabric web 4 by means of one or more ventilators 14 via the upper and lower nozzle systems 5, 6. The quantity of additional air 8 supplied to the processing gas is discharged in a corresponding quantity in the form of exhaust air 15 via a central device 16.

All other half-fields 1b to 3a are constructed in a similar manner, the supply of the processing gas to the nozzle systems 5, 6 always being carried out alternately from one side or the other in the case of successive half-fields.

In the last half-field 3b, there is received the central heating system 10 for heating the additional air which is connected to the mixing devices 13b of the processing fields 1 to 3 via the ring circuit 11. In the illustrated embodiment, it substantially comprises a central combustion chamber 10a and a central heat exchanger 10b, the two ends of the ring circuit 11 being connected to the combustion chamber 10a so that additional air which is not consumed is returned to the central heating system 10 and can be used again.

The central heating system further has a connection 17 which is provided on the heat exchanger 10b for supplying fresh air 18. The heat exchanger is further connected to the devices 16 for discharging the exhaust air 15 so that the fresh air 18 supplied via the connection 17 is preheated with the exhaust gases 15 from the processing fields before the fresh air in the combustion chamber 10a is passed on.

In the embodiment illustrated, there is arranged downstream of the processing field 3 another cooling field 20 which is operated with the fresh air 18 and which has a connection 20a for supplying the fresh air 18 and a connection 20b which is connected to the central heating system 10 for discharging preheated fresh air. The cooling field 20 can be constructed optionally as an oblique blasting ventilation zone 20c or as an aeration zone 20d, the fresh air either being blown from above and below onto the fabric web 4 (oblique blasting ventilation zone 20c) or the fresh air being urged and/or drawn by the fabric web 4 (aeration zone 20d).

The central heating system is controlled by means of a control device which is indicated only schematically (see FIG. 1b). In this manner, the pressure, for example, in the ring circuit 11 after the last connected half-field is measured by means of a pressure sensor 22 and is used to adjust the quantity of fresh air. Furthermore, the combustion chamber 10a is controlled in accordance with at least one parameter of the exhaust air, in particular in accordance with the carbon content and/or the humidity and/or the temperature of the additional air 8c, with both combustion air 10c, combustion material 10d and the quantity of the fresh air being able to be adjusted.

If, for example, the carbon content is too high, the quantity of exhaust air and consequently the quantity of combustion gas is increased, and correspondingly decreased with a content which is too low. By means of appropriate adjustment devices, the device is operated in the predetermined desired ranges or with predetermined desired values.

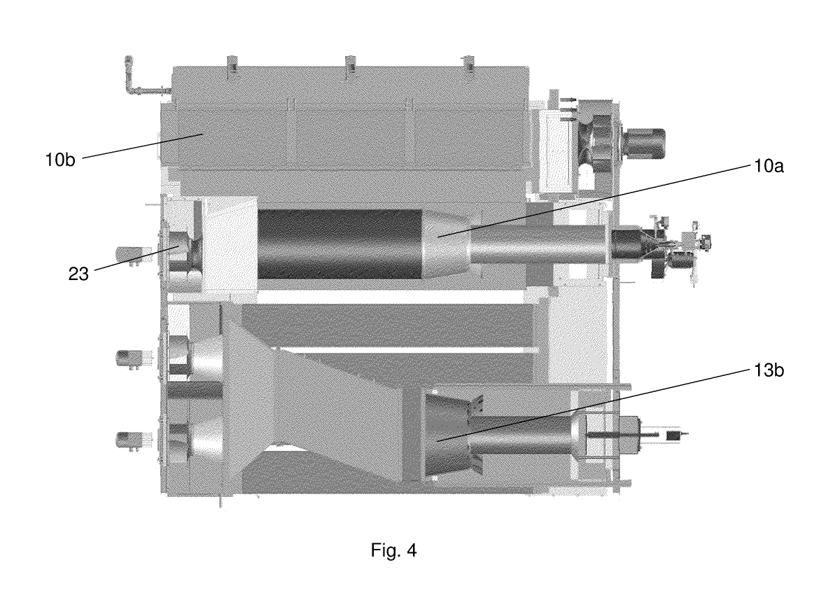

The entire device is accommodated in a housing 24, in particular the ring circuit 11 and the central devices 16 for discharging the exhaust air and the central heating system also being arranged inside the housing. The central heating system is preferably arranged below the nozzle systems 5, 6 of the last processing field 3 in the transport direction (arrow 4a). As can be seen in particular from FIGS. 3 and 4, the combustion chamber 10a and the heat exchanger can be installed below the lower nozzle system 5. There is still also sufficient space for the mixing device 13b of the last processing field. In this manner, a very compact device is produced.

In the embodiment described above, the additional air supplied to the individual processing fields by means of the ventilator 23 via the ring circuit 11 is composed of exhaust gas of the combustion chamber 10a, recirculated additional air and fresh air. For particularly sensitive fabric webs, however, the exhaust gas contained is disadvantageous. For this application, therefore a second embodiment with indirect heating of the recirculation air is described below.

In principle, it is naturally conceivable to provide a correspondingly large heat exchanger in place of the combustion chamber 10a. However, since the temperature of the additional air in the ring circuit is intended to be in the range of from 250 to 350° C., this is not currently cost-effective owing to losses via the ring circuit.

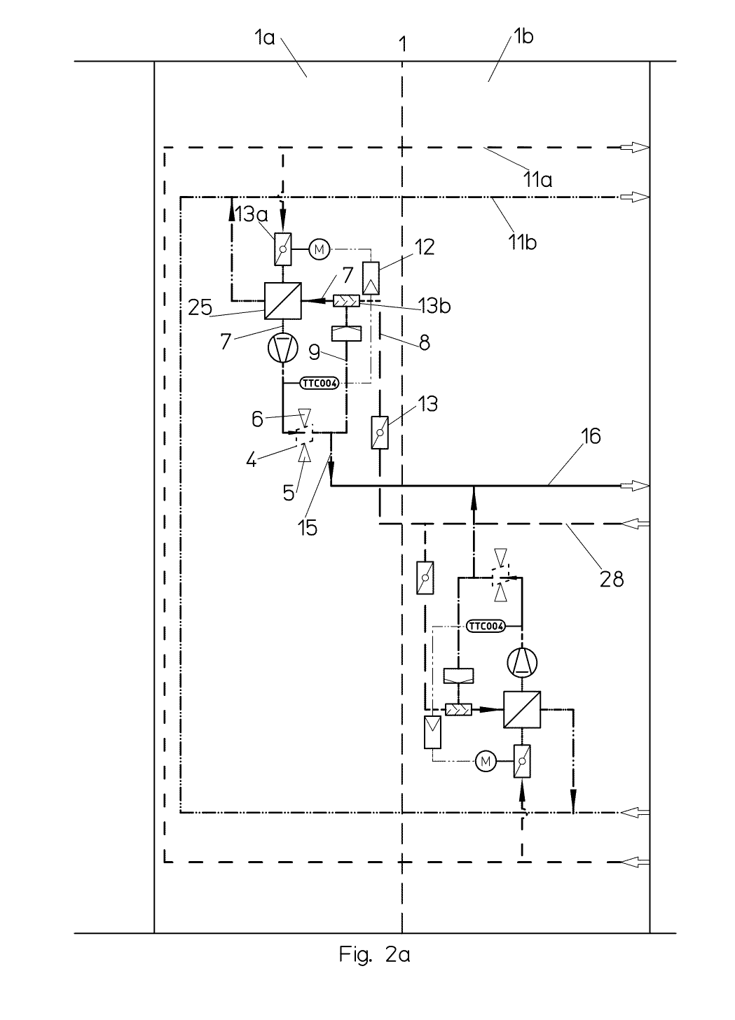

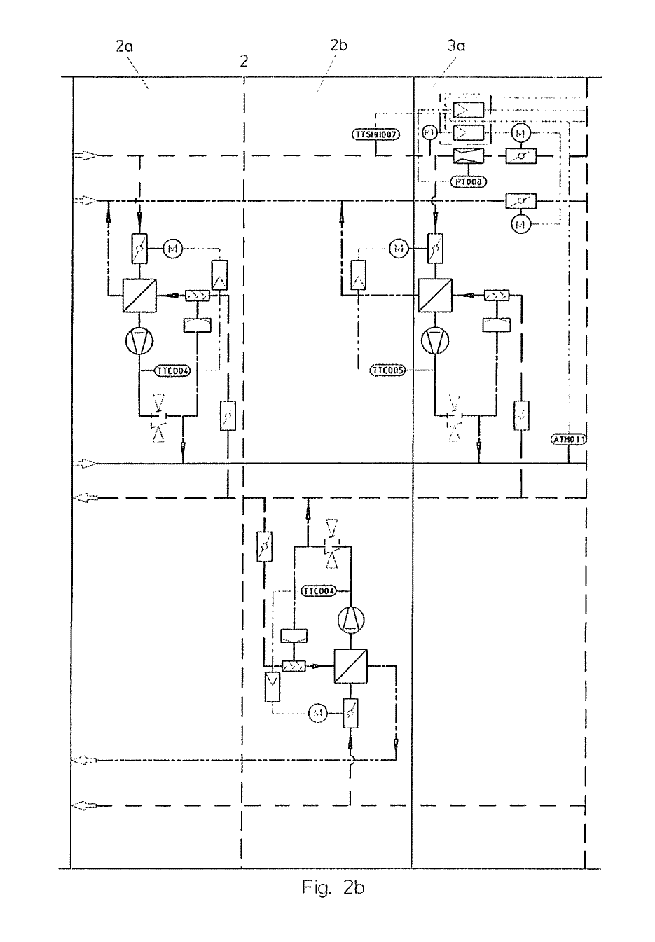

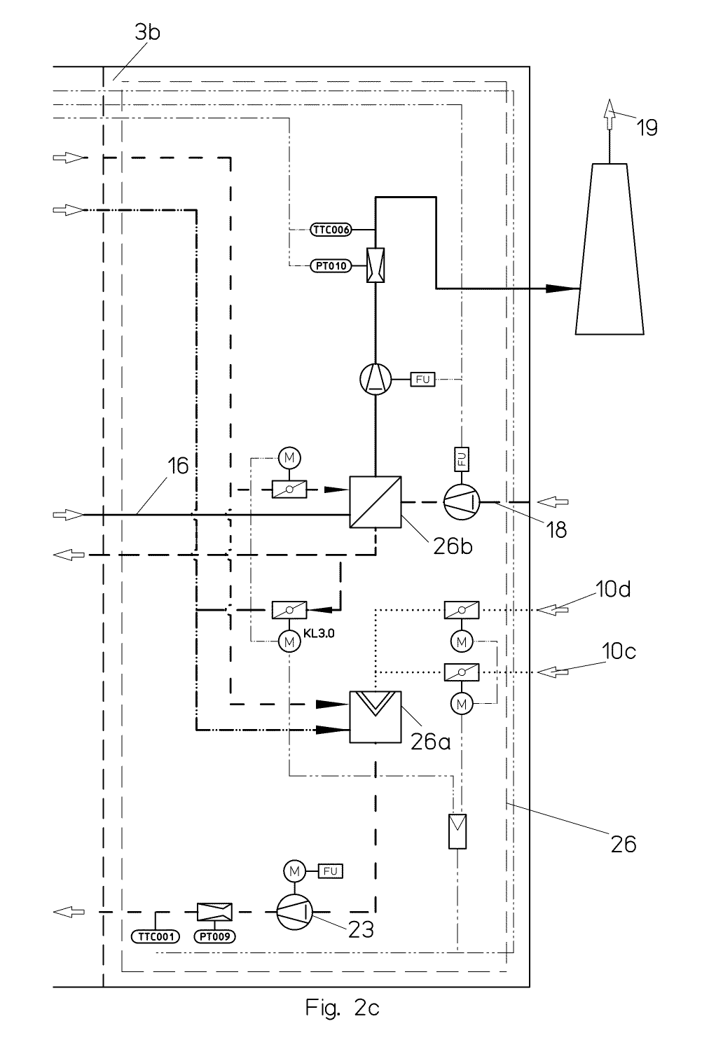

With reference to FIGS. 2a to 2c, therefore it is proposed that a heat exchanger 25 for indirectly heating the processing gas 7 be arranged in each processing field or each half-field. As before, however, a central heating system 26 is provided which again comprises a central combustion chamber 26a and a central heat exchanger 26b.

The hot sides of the heat exchanger 25 in the individual processing fields are connected, via a ring circuit which in this instance is constructed with supply lines and return lines 11a, 11b, to the central combustion chamber 26a of the central heating system 26. The hot ring circuit air which is produced in the combustion chamber 26a is available to the individual heat exchangers via adjustment members 27 in order to indirectly heat the processing gas depending on requirements.

In the central heat exchanger 26b, fresh air 18 is heated by means of the hot exhaust air 15 of the processing fields and is supplied to the processing fields as additional air via lines 28. The exhaust air used in the heat exchanger 26, optionally after filtering, is discharged as outgoing air 19.

As in the first embodiment, the processing gas is adjusted by mixing the pre-heated additional air 8 with the circulating recirculation air 9 before it is indirectly heated in the heat exchanger to the required temperature, for example, of 200° C.

The circuit air which is not used is returned again to the central combustion chamber 26a. In place of supply and return lines 11a, 11b, it would of course also be possible to provide only a single ring circuit. When two lines are used, the individual processing fields are arranged in a parallel arrangement; when one line is used, this corresponds to the processing fields being arranged one behind the other. It would also be conceivable for the supply and return lines 11a, 11b to be joined together to form one line after the last processing field.

In a similar manner to the first embodiment, a cooling field can again be arranged downstream of the last processing field in order to preheat the fresh air upstream of the heat exchanger 26b.

Furthermore, the central heating system is again arranged below the nozzle system of the last processing field. The device for thermally processing the fabric web further has the control device described above.

The central heating system can be connected to all the processing fields of the device for thermally processing web-like fabric webs or cover only a part of the device, for example, the front or rear half. However, it is also conceivable for a first central heating system to be provided for the front half and a second central heating system to be provided for the rear half.

If a suction zone for the fabric web is provided at the beginning of the device, this is particularly suitable for preheating the fresh air.

1. Device for thermally processing web-like fabric webs ⁽⁴⁾ having
a plurality of successive processing fields for acting on the fabric web with a processing gas,
transport means for conveying the fabric web through the processing fields in the extended state,
devices for supplying additional air to the processing fields,
devices for discharging exhaust air from the processing fields,
a mixing device which is provided in each processing field and which is connected to the devices for supplying the additional air and which has an adjustment member adjusting the ratio of additional air to circulating recirculation air present in the processing gas, and
means for adjusting the temperature of the processing gas, characterised in that the means for adjusting the temperature of the processing gas have a central heating system which is connected to the plurality of processing fields by means of a ring circuit.

2. Device according to claim 1, characterised in that the central heating system is constructed to heat the additional air and the devices for supplying the additional air are formed by the ring circuit, which is connected to the adjustment member of the mixing devices of the plurality of processing fields.

3. Device according to claim 1, characterised in that the processing fields each comprise a heat exchanger for heating the processing gas, the heat exchangers of the processing fields being connected to the central heating system at their hot side via the ring circuit.

4. Device according to claim 3, characterised in that the central heating system has a first heating device and a second heating device,
the first heating device being constructed for heating circuit air, and being connected via the ring circuit to the hot side of the heat exchangers in the plurality of processing fields and
the second heating device being constructed for heating the additional air and being connected to the plurality of processing fields via the devices for supplying the additional air by means of an adjustment member and the mixing device.

5. Device according to claim 1, characterised in that the central heating system has a connection for supplying fresh air.

6. Device according to claim 1, characterised in that there is arranged, downstream of the processing fields, a cooling field which is operated with fresh air and which has a connection for supplying fresh air and a connection which is connected to the central heating system for discharging preheated fresh air.

7. Device according to claim 1, characterised in that there is provided a control device for controlling the central heating system in accordance with at least one parameter of the exhaust air, said parameters selected from the group consisting of the carbon content, the moisture and the temperature of the additional air.

8. Method for thermally processing web-like fabric webs,
the fabric web being conveyed through a plurality of successive processing fields and acted on with a processing gas in the processing fields,
additional air being supplied to each processing field,
exhaust air being discharged from the processing fields,
the processing gas being adjusted in each processing field by mixing additional air with circulating recirculation air and
the processing gas being adjusted to a predetermined temperature, characterised in that the temperature of the processing gas is adjusted by means of a central heating system which is connected to the plurality of processing fields by means of a ring circuit.

9. Method according to claim 8, characterised in that the additional air is heated by means of the central heating system and is supplied to the individual processing fields via the ring circuit and excess additional air is returned to the central heating system.

10. Method according to claim 8, characterised in that, in each processing field, a heat exchanger is used for heating the processing gas, the hot sides of the heat exchanger being supplied with hot circuit air via the ring circuit as heat-carriers.
